(19) United States
(12) Patent Application Publication
(10) Pub. No.: US 2023/0406161 A1
(43) Pub. Date: Dec. 21, 2023

(54) FIXING DEVICE FOR THE POWER-OPERATED FIXING OF AN OBJECT IN A VEHICLE WITH THE AID OF AT LEAST ONE VARIABLY ELECTRICALLY CONTACTABLE FIXING ELEMENT

(71) Applicants: Brose Fahrzeugteile SE & Co. Kommanditgesellschaft, Coburg, Coburg (DE); Hirschmann Automotive GmbH, Rankweil (AT)

(72) Inventors: Volker DEINHARD, Bamberg (DE); Markus BAUERNFEIND, Coburg (DE); Eike FROEHLICH, Bamberg (DE); Mario WAZANINI, Steindorf (DE); Steffen FOLGER, Burgebrach (DE); Susanne KOPF, Dornbirn (AT); Markus BISCHOF, Schlins (AT); Marcel PERLE, Satteins (AT); Manuel LINSEDER, Rankweil (AT); Christoph NIES, Wuerzburg (DE)

(21) Appl. No.: 18/248,221

(22) PCT Filed: Sep. 23, 2021
(86) PCT No.: PCT/EP2021/076221

§ 371 Date: Apr. 6, 2023

(30) Foreign Application Priority Data
Oct. 6, 2020 (DE) 10 2020 212 627.5

(51) Int. Cl. B60N 2/02; B60K 1/04

(52) U.S. Cl. CPC B60N 2/02246; B60K 1/04

(57) ABSTRACT

It is provided a fixing apparatus for fixing an object to a fixing face in a vehicle, having at least one fixing element, which is constructed for fixing the object having a fixing portion which for engagement in a fixing opening can be introduced along an adjustment axis into the fixing opening. The fixing element has on an outer covering face of the fixing portion a coupling region which in at least two different adjustment positions of the fixing element, in which the fixing portion can be introduced in each case into the fixing opening, permits an electrical contacting by a counter-element.

### CROSS REFERENCE TO RELATED APPLICATIONS

The present application is a U.S. National Phase of International Application No. PCT/EP2021/076221 entitled “FIXING DEVICE FOR THE POWER-OPERATED FIXING OF AN OBJECT IN A VEHICLE WITH THE AID OF AT LEAST ONE VARIABLY ELECTRICALLY CONTACTABLE FIXING ELEMENT,” and filed on Sep. 23, 2021. International Application No. PCT/EP2021/076221 claims priority to German Patent Application No. 10 2020 212 627.5 filed on Oct. 6, 2020. The entire contents of each of the above-listed applications are hereby incorporated by reference for all purposes.

### BACKGROUND

The proposed solution relates to a fixing apparatus for fixing an object to a fixing face in a vehicle.

The fixing face may, for example, be an interior face of the vehicle, such as, for example, a loading face of the vehicle interior, on which interior objects, for example, in the form of vehicle seats, tables and/or central consoles can be fixed. For example, it is known from DE 10 2017 210 608 A1 to construct such interior objects to be able to be adjusted so as to be guided in a non-mechanical manner on the interior face. DE 10 2017 210 608 A1 proposes, for example, in this context enabling an adjustment of an interior object via an air cushion or via a rolling apparatus. In this instance, however, it remains undecided at which locations a correct fixing of such an interior object is intended to be enabled and how such a fixing position is predetermined where applicable.

DE 10 2004 046 070 A1 further discloses a fixing apparatus for fixing interior objects on a fixing face which is defined by a base plate in a vehicle. In this instance, pin-like fixing elements in the form of locking pins engage in holes of the fixing face and can be locked thereto in order to fix the interior object to the fixing face. The locking elements are supported so as to be able to be longitudinally displaced on an interior object and can, depending on the positioning of the interior object, be introduced manually in the current position of the interior object into fitting holes and locked thereto. For the positioning of an interior object in different positions, a plurality of holes are provided as fixing openings for the fixing elements, wherein the holes are arranged in a grid on the base plate.

### SUMMARY

Based on this, an object of the proposed solution is to provide a possibility by means of which a flexible arrangement of an object on a fixing face in a vehicle is improved.

This object is achieved with a fixing apparatus having features as described herein.

A proposed fixing apparatus has a fixing element having a fixing portion which can be introduced along an adjustment axis into a fixing opening and on the outer covering face of which there is provided a coupling region which, in at least two different adjustment positions of the fixing element, in which the fixing portion can be introduced in each case into the fixing opening, permits an electrical contacting by a counter-element.

In a proposed fixing apparatus, a fixing portion of a fixing element which is provided for fixing consequently integrates a specifically configured coupling region for an electrical contacting with a counter-element. In this instance, the coupling region is configured in such a manner that an electrical contacting with and consequently connection to the counter-element is enabled in at least two different adjustment positions of the fixing element. The fixing element can consequently be introduced into a fixing opening with the fixing portion thereof in at least two different adjustment positions and the fixing portion can be connected to the counter-element. In this manner, the fixing element does not have to be introduced into the opening in precisely one specific adjustment position with respect to the fixing opening in order to subsequently permit an electrical contacting with a counter-element. Via the coupling region, instead on an outer covering face of the fixing portion at least one additional contacting possibility for the counter-element is provided when the fixing element is introduced into the fixing opening in another adjustment position with respect to the fixing opening with the fixing portion thereof. A counter-element which is positioned independently of the adjustment positions of the fixing element and which is consequently always positioned identically can thus be correctly connected to the fixing portion which engages in the fixing opening for connection to at least one power and/or signal line, even when the fixing element is in another adjustment position. This increases the variability when a proposed fixing apparatus is used since an object can be arranged on a vehicle-side fixing face in at least two different adjustment positions of the fixing element without dispensing with an electrical contacting by a counter-element. If the counter-element is, for example, provided at the vehicle side and it is assumed that the adjustment position of the fixing element on the object is dependent on an orientation of the object on the fixing face, with the proposed solution an object can be fixed in at least two different orientations on the fixing face with subsequent electrical contacting by the counter-element.

In one variant, there is provision in a fixing position of the object and with a fixing element which is adjusted into a fixing position in which the fixing portion thereof engages into the fixing opening, for an electrical connection to be provided between a vehicle-side energy source and the interior object via the counter-element. A corresponding electrical connection serves, for example, to charge at least one energy store of the object which is placed in the vehicle, in particular a battery of the object, and/or the supply of at least one consumer on or in the object. The at least one consumer may, for example, comprise a display or an additionally provided, electrically operable drive of the object, via which an adjustment portion of the object can be adjusted in a manner actuated by an external power source. If the object is, for example, an interior object for a vehicle interior of the vehicle, via the electrical connection between the fixing portion and counter-element a connection of the object to a vehicle-side power supply and/or to a vehicle-side electronic control system may be produced. Subsequently, for example, a charging of electronic components provided on the object and/or the control thereof may thereby be carried out. If an interior object is, for example, formed by a vehicle seat, an additional electrically operable drive may be provided for the adjustment of a headrest, a seat cushion and/or a backrest of the vehicle seat as an adjustment portion. Alternatively or additionally, the electrical connection can be used for connection to a vehicle-side bus system, for example, in order to transmit signals of a vehicle-side protection and/or retention system, in particular of an airbag system, to an interior object or to transmit from an interior object to such a system.

The counter-element may be displaceably supported in order to connect the counter-element to the coupling region after the fixing portion has been introduced into the fixing opening. In such a variant, an electrical connection between the fixing portion and the counter-element can consequently first be brought about by means of a separate displacement of the counter-element.

One variant makes provision, for example, for the coupling region to permit an electrical contacting with the counter-element when the fixing portion engages in the fixing opening both in a first adjustment position of the fixing element and in at least a second adjustment position of the fixing element, wherein the second adjustment position (with respect to the fixing opening) can be assumed starting from the first adjustment position by rotating the fixing element about the adjustment axis. The fixing element can in this instance consequently be present with respect to the first adjustment position in a second adjustment position which is rotated about the adjustment axis with respect to the fixing opening and in which the fixing portion can not only also be introduced into the fixing opening, but instead in which an electrical contacting is also possible with the counter-element on the coupling region. In this manner, in each of at least two different adjustment positions of the fixing element with respect to the fixing opening which can be transferred into each other by rotating the fixing element about the adjustment axis, not only is an engagement of the fixing element in the fixing opening possible, but also a correct electrical contacting with one and the same counter-element.

For example, the coupling region permits an electrical contacting with the counter-element—when the fixing portion engages in the fixing opening—in two different adjustment positions, in which the fixing element is rotated through more than 90°, in particular through 180° about the adjustment axis. The at least two adjustment positions of the fixing element consequently differ from each other in that the fixing element in a (first) adjustment position in comparison with the other (second) adjustment position is rotated through more than 90°, in particular through 180° about the adjustment axis.

The coupling region may in principle have contacts which are connected to at least one signal line. The signal line is in this instance, for example, guided inside the fixing portion. In one variant, the contacts can be coupled to the counter-element in at least two different spatial directions which are in each case perpendicular to the adjustment axis. This includes in particular the variant which has been explained above and in which in two adjustment positions which are rotated through 180° relative to each other a coupling to the counter-element is possible. The coupling region consequently has contacts which are accessible, for example, along two mutually opposing spatial directions which extend in each case perpendicularly to the adjustment axis for a coupling to a counter-element.

In one variant, the coupling region has for a plug-in connection to the counter-element in the at least two different adjustment positions at least two plug-in connectors on the outer covering face of the fixing portion. With such an adjustment-dependent plug-in connection to the coupling region, the two plug-in connectors may, for example, be connected to each other by means of a central portion of the fixing portion. A signal line which is connected to the contacts is then guided, for example, in the central portion. In the central portion, contacts can then also be arranged so as to be accessible via each of the plug-in connectors so that the corresponding contacts are accessible from different directions via a plug-in connector in each case. It is consequently not then necessary for each plug-in connector to separately provide contacts which are in each case connected to the signal line on the fixing portion.

In principle, for example, the contacts may be in the form of socket contacts. An embodiment with socket contacts affords, for example, with regard to the variant explained above having at least two plug-in connectors the advantage that an end of a socket can be associated with one plug-in connector and the other end of the same socket can be associated with another plug-in connector so that via the same socket a contact for two plug-in connectors provided in the coupling region is provided.

In one variant, a plurality of socket contacts are arranged one behind the other in an extent direction, which is parallel with the adjustment axis, of the fixing portion.

In an alternative variant, on the coupling region—for the electrical contacting by the counter-element—there are provided contacts which are in the form of round contacts and in which in each case a contact face which is provided for contacting the counter-element extends along the outer covering face of the fixing portion in a circumferential direction about the adjustment axis. In such a variant, a coaxial contacting is consequently enabled via the coupling region. For example, the fixing portion is in this instance constructed to be circular in cross section. The round contacts may in this instance be constructed in each case so as to extend in an annular manner along the outer covering face of the fixing portion.

For the provision of different contacts for the power supply and/or signal transmission, two ring contacts can be separated from each other by at least one insulating portion. Between two round contacts of the fixing portion there is consequently at least one insulating portion comprising an electrical insulator.

In one variant, there is provided at least one adjustable locking element which is separate from the fixing element and which locks in interaction with the fixing portion which engages in the fixing opening the fixing element in the fixing opening and blocks the fixing portion against removal from the fixing opening. In addition to the fixing portion which can be displaced along the adjustment axis, there is consequently provided at least one adjustable locking element which can be adjusted itself. The locking element is in this instance not adjustably supported on the fixing element itself, but instead can engage with the fixing portion of the fixing element only when the fixing portion has been correctly introduced into the fixing opening. In this instance, it is in principle insignificant whether the fixing element is provided at the object side or at the fixing face side and conversely whether the at least one locking element is provided at the fixing face side or object side, Instead, it is decisive that two separately adjustable elements (fixing element and locking element) and consequently also two separate adjustment movements are provided in order to ensure a fixing of an object to a fixing face. Accordingly, the two different adjustment movements of the fixing element with the fixing portion thereof, on the one hand, and the locking element, on the other hand, can be coordinated with each other but can in principle be controlled independently of each other (manually or actuated by an external power source).

In one variant, the at least one locking element can be adjusted in order to lock the fixing element into a locking position in which the at least one locking element is connected to the fixing portion in a positive-locking manner. The positive-locking connection may also, where applicable, involve a non-positive-locking connection. Via the positive-locking connection between the locking element and the fixing portion, a more effective locking action and consequently securing of the fixing portion in the fixing opening can be achieved. Consequently, the locking element can in this instance, in order to lock the fixing element to the fixing opening, be brought into positive-locking engagement with the fixing portion by the at least one locking element being adjusted into the locking position thereof.

For the positive-locking connection there may be provided on the fixing portion an engagement region which is constructed, with respect to the adjustment axis, to be radially inwardly offset with respect to regions of the fixing portion adjacent to the engagement region. In one variant, the at least one locking element for locking the fixing element to the fixing opening then moves into engagement with this engagement region. The recessed engagement region may, for example, be formed on the fixing portion by a groove, in particular by an annular groove which extends around the adjustment axis.

For the locking to the fixing portion which has been introduced into the fixing opening, the at least one locking element may be rotatably supported about a rotation axis which extends parallel with or perpendicular to the adjustment axis of the fixing portion. The locking element then forms in this instance, for example, a portion of a bayonet closure or a pivotable curved portion in order to fix the fixing portion to the fixing opening. The fixing portion can thus be introduced, for example, below or on the fixing opening into a rotary member which is formed by the locking element and which, as a result of a rotation about the rotation axis parallel with the adjustment axis, ensures a locking of the fixing portion. For example, the rotary member may in this instance be constructed in the manner of a nut which engages behind a radially protruding pin or web on the fixing portion in the event of a rotation, and thereby locks the fixing portion in a positive-locking manner A corresponding rotation of the rotary member, in particular the nut which is formed thereby, may, for example, be. 270°. Alternatively, the fixing portion may when introduced into the fixing opening act on a portion of a rotatably supported locking element which is formed with a curved bracket portion in order to bring the bracket portion into positive-locking engagement with the fixing portion by means of a pivot movement of the locking element.

In an alternative variant, the at least one locking element is displaceably supported in an adjustment direction which extends transversely relative to the adjustment axis of the fixing portion. If in this instance the fixing portion is introduced into the fixing opening along the adjustment axis, consequently, there is subsequently—when the fixing portion has assumed a predetermined introduction position—a displacement of the locking element transversely relative to the introduction direction of the fixing portion.

For example, the at least one locking element comprises a displaceably supported carriage. For the displaceable support of the carriage, for example, a physical guide may be provided. For example, at least one guide rail, on which the carriage is displaceably supported, is provided.

In principle, the carriage may in this instance be manually displaceable so that an object fixing can be implemented manually by a user. Alternatively, a motorized drive device for an external-power-operated adjustment of the carriage may be provided. In one variant, for example, a spindle drive is provided for the adjustment of the carriage.

For the secure locking of the fixing portion on the fixing opening by means of the displaceable carriage, one variant makes provision for there to be provided in the carriage a locking opening in which the fixing portion, which has been introduced into the fixing opening, of the fixing element engages. In this manner, the carriage can be displaced in the adjustment direction from a release position into a locking position in which the fixing portion is locked to the locking opening of the carriage. For example, the locking opening has first and second opening portions, wherein, in the release position of the carriage, the fixing portion of the fixing element on the first opening portion can be introduced into the locking opening and subsequently by means of a displacement of the carriage in the adjustment direction the second opening portion of the locking opening can be brought into engagement with the fixing portion of the locking element. The opening portions of the locking opening may in this instance have different dimensions and may in particular together define a keyhole-like (opening) contour. Whilst the first (larger) opening portion consequently enables the introduction of the fixing portion into the locking opening of the carriage which is in the release position, the other second (smaller) opening portion is sized in such a manner that the fixing portion can no longer be withdrawn along the adjustment axis from the locking opening and consequently out of the fixing opening.

In order to support the most play-free possible locking of the fixing portion on the at least one locking element, one variant makes provision for the carriage to be resiliently pretensioned in the adjustment direction, that is to say, precisely in the direction in which the carriage is intended to be adjusted in order to lock the fixing element to the fixing opening. For resilient pretensioning, there may be provided at least one resilient element which acts on, in particular pushes or pulls, the carriage with a pretensioning force which acts in the direction of a locking position.

In one variant, the carriage is resiliently pretensioned by means of at least one resilient element, which is supported, on the one hand, on a portion of the carriage and, on the other hand, on a support member which can be adjusted in the adjustment direction. The support member can consequently also be adjusted in the adjustment direction for example, by being able to be driven itself or forming a portion of a base which carries the carriage. At the same time, the carriage is displaceably retained relative to the support member and additionally pretensioned in the adjustment direction by means of the at least one resilient element. For the locking of the fixing portion which has been introduced into the fixing opening, the support member is consequently adjusted together with the carriage in the first adjustment direction, for example, by means of a motorized drive. In a locking position which is then assumed, the carriage is via the at least one resilient element which is supported on the support portion additionally loaded in the adjustment direction and consequently into the locking position, in which the carriage is in positive-locking engagement with the fixing portion.

In principle, the at least one locking element may have at least one clamping portion, via which the fixing element can be displaced with the fixing portion which is introduced into the fixing opening along the displacement axis in a clamping position. Via the clamping portion of the locking element, it is consequently possible to achieve an even only slight displacement of the fixing portion in order to maintain the fixing element in a tensioned state when it is correctly fixed to the fixing opening by means of the at least one locking element and is blocked against displacement from the fixing opening. It is thereby readily possible to ensure, for example, a play-free or rattle-free locking on the fixing opening and to apply where applicable a desired pressing pressure to the object to be fixed in the direction of the fixing face.

For example, the clamping portion has a ramp region which extends in an inclined manner relative to the adjustment axis of the fixing element and which can be adjusted along an engagement region of the fixing portion, which has been introduced into the fixing opening, of the fixing element. The ramp region is then displaced, when the locking element is adjusted into its locking position, by means of sliding on the engagement region along the fixing element into the clamping position. Thus, the ramp region which extends in an inclined manner relative to the adjustment axis is then, for example, guided on a portion, in particular a web, pin or shoulder of the fixing portion, which protrudes radially with respect to the adjustment axis and presses the fixing portion in the original introduction direction into the clamping position. The fixing portion is thereby loaded by the ramp region into the clamping position.

A proposed fixing apparatus may in particular be provided to fix an object to a fixing face which is secured to the body in a vehicle, wherein the fixing apparatus can be provided on the fixing face or on the object itself. For example, for a symmetrical force distribution and crash-secure locking of the object, a plurality of fixing elements are provided with a displacement element which is longitudinally adjustable herein or hereon. For example, one variant makes provision for four fixing elements to be arranged at the object side in order to fix the object to four fixing openings in an assumed fixing position.

The fixing element itself is constructed so as to be non-adjustable in one variant. For example, the fixing element is provided in a non-movable and rigid manner on the object. In order to accordingly introduce the object-side fixing element into a fixing opening, the object is, for example, inserted with the fixing element which protrudes at a lower side at an appropriate position on the fixing face. Alternatively, a motor-controlled or manual lowering of the object in the direction of the fixing face may be provided in order to bring the fixing element into engagement with a fixing opening. In this instance, for example, the object is configured and provided to be able to assume two different positions with respect to the fixing face. The object may thus, for example, in a first position in which the fixing element is spaced apart with respect to the fixing face, be able to be adjusted on the fixing face, in particular be able to be adjusted in a motor-controlled manner. If a desired fixing position is reached, the object can be lowered into a second position in the direction of the fixing face, whereby the fixing element (and where applicable still other fixing elements which are provided on the object) is then inserted into a corresponding fixing opening—which is then opposite the fixing element—on the fixing face.

One variant makes provision for the at least one object to be in the form of an interior object and to comprise at least one battery-operated motorized drive device for a non-mechanically guided displacement of the interior object on an interior surface, which acts as a fixing face, of the vehicle. The at least one fixing element is then provided for fixing the at least one interior object in a fixing position on the interior face, wherein reaching this fixing position may be able to be detected by means of an electronic detection device of the vehicle.

Via the at least one battery-operated motorized drive device, the at least one interior object can be displaced in a non-track-guided manner on the interior face. There is consequently no guide or provision of a displacement path for the interior object by a rail, a track or a slotted member. Instead, the interior object can be freely displaced on the interior surface. Alternatively, however, the object to be fixed, in particular the interior object, may also be able to be displaced manually to a desired fixing position.

The fixing positions at which the interior object can be fixed to the interior face by means of the at least one fixing element may be predetermined on the interior face. For example, a large number of possible fixing positions are predefined on the interior face. Via the at least one detection device, it may be able to be detected electronically in this case when the interior object has reached one of the predefined fixing positions in order to then initiate a displacement of the at least one fixing element into the fixing position thereof and thereby to fix the interior object at the fixing position which has been reached.

In one variant, the motorized drive device has at least one rolling member or a chain for the contact with the interior face and the movement of the interior object on the interior face. A “rolling member” is in this instance intended to be understood to be particularly a roller, a wheel or a tire. Via a corresponding drive device having at least one rolling member or chain, the interior object can be adjusted in a battery-operated manner along the interior face, where applicable controlled remotely and/or by means of the electronic detection device.

In one variant, the at least one motorized drive device has an omnidirectional drive. Such an omnidirectional drive permits the adjustment of the interior object in any directions in a spatial plane on the interior surface. To this end, an omnidirectional drive has, for example, at least one omni wheel.

Via the at least one fixing element which is adjusted at a fixing position in the fixing position thereof, the interior object may be fixed to a base anchoring of the interior face. Using the at least one fixing element which is present in the fixing position thereof, consequently, the interior object is then anchored at the vehicle side and locked in a crash-secure manner. This includes in particular that a fixing element or a plurality of fixing elements is/are constructed and configured to anchor the interior object at a fixing position in a crash-secure manner and consequently to secure the interior object against displacement on the interior face even under high acceleration forces which occur in the event of a crash.

In principle, the fixing element may be displaceably supported on the object or on the fixing face. For example, in one variant, there is provision for the at least one fixing element to be provided so as to be able to be displaced on the object, wherein the fixing element is adjusted into a fixing position when the object has reached a predetermined fixing position. Alternatively or additionally, at least one fixing element may be arranged on the fixing face which in the fixing position thereof fixes the object which is present in a correctly assumed fixing position. In particular, a fixing of the object via a combination of fixing elements which are adjustably supported on the fixing face and on the object may be provided.

On the fixing face a large number of possible fixing positions may be predetermined. In this manner, for example, in a vehicle interior, a plurality of different fixing positions for an interior object or for a plurality of interior objects may be predefined in order to predetermine a finite number of locations on the interior face at which an interior object can be correctly fixed (in a crash-secure manner). Regardless of this, via the battery-operated motorized drive device a displacement path for reaching a fixing position is not predetermined and can be selected in a flexible manner, in particular in accordance with the arrangement and/or the desired position of one or more other interior objects and in accordance with any obstacles on the interior face.

The electronic detection device via which, for example, during a movement of an interior object along an interior face, the position thereof can be detected comprises in one variant at least one component which is provided on the interior object. This component may, for example, be a passive or an active component, that is to say, a (passive) component which can be detected by a sensor element of the detection device, or an (active) component which actively transmits signals to one or more receivers of the electronic detection device and/or detects using sensors at least one measurement variable which is representative of the environment of the interior object and via which at least the reaching of a predetermined fixing position on the interior face of the vehicle interior can be determined.

The electronic detection device may in principle be configured to detect the position of the interior object during movement on the interior face
visually (for example, by means of infra-red) and/or
magnetically and/or
on the basis of sound, in particular on the basis of ultrasound and/or
on the basis of radio waves, in particular on the basis of at least one UWB signals (“UWB”: “ultra-wideband”) and/or
on the basis of laser beams, in particular on the basis of a lidar method (“Lidar”: “light detection and ranging”).

In one variant, the electronic detection device comprises at least two sensor elements which are based on different measurement principles in order to detect the reaching of the fixing position by the interior object. In such a variant, different sensor elements are, for example, consequently combined with each other in order to prevent or at least to reduce erroneous detections. For example, by means of sensor elements which are based on different measurement principles, the reaching of a fixing position can be detected in a redundant manner and a fixing via the at least one fixing element is released only when both sensor elements which are based on different measurement principles detect the reaching of the fixing position. Alternatively or additionally, sensor elements which are based on different measurement principles may be provided to detect different travel paths or different phases during a movement of the interior object. For example, a first sensor element based on a first measurement principle (and consequently where applicable based on a first measurement variable and/or a first resolution) can detect a position of the interior object in a first radius about a predetermined fixing position, whilst another second sensor element based on another second measurement principle (and consequently where applicable based on another second measurement variable and/or another, second resolution) can detect a position of the interior object in a second radius about the predetermined fixing position, wherein the second radius is smaller than the first radius. The first sensor element can consequently be used for rough positioning, whilst using the second sensor element a fine positioning can be implemented.

A combination of different sensor elements may in particular involve a combination of the above-mentioned measurement principles (visual, magnetic, sound-based, etcetera) on the basis of which the electronic detection device can detect a position of the interior object during the movement on the interior surface.

In one variant, the object comprises at least one connection for coupling to an external, vehicle-independent energy source. Such a connection comprises, for example, a plug-in connector for coupling to an electrical energy source so that an interior object outside the vehicle can be connected to a power source and, for example, an energy store of the interior object can be charged.

In principle, at least one adjustment portion which is provided on an interior object may be adjustable when the interior object is fixed to the interior face. For example, an adjustment portion of the interior object can be adjusted with respect to the interior face and/or with respect to a base, which is fixed to the interior face, of the interior object at least or only when the interior object is correctly fixed by means of the at least one fixing element in a fixing position on the interior face. Consequently, the interior object may, for example, by means of the battery-operated drive thereof, no longer be displaced in a mechanically guided manner on the interior face and consequently along a spatial plane which is defined thereby when in addition a component of the interior object or an adjustment portion which is arranged thereon is intended to be adjusted. This includes, for example, the fact that a vehicle seat has as an interior object an adjustable adjustment portion in the form of a headrest, a seat cushion and/or a backrest which can be adjusted independently of the battery-operated motorized drive device only when the vehicle seat has assumed a correct fixing position on the interior face of the vehicle and has been accordingly fixed.

An interior object of a proposed vehicle may in particular be a vehicle seat, a (central arm) console or a table. Such an interior object is then, for example, inside the vehicle interior—in particular with a stationary vehicle—freely displaceable and—when the vehicle is moving—fixed in a fixing position by means of the at least one fixing element on the interior face.

In principle, a proposed fixing apparatus can also be used for fixing a child's pram or for a vehicle bicycle stand or vehicle bicycle carrier. The bicycle stand or bicycle carrier is in this instance part of a retention apparatus for at least one bicycle, which can be fixed to an interior face of the vehicle by means of the fixing apparatus.

In one variant which is based thereon and in which the fixing apparatus also provides an electrical connection to a vehicle-side energy source and/or a vehicle-side electronic control system, a retention apparatus which is connected to the vehicle by means of the fixing apparatus then affords the possibility of charging an electric bike which is connected thereto. Thus, via the fixing apparatus, an electrically conductive connection to the power supply of the vehicle-side on-board network is then produced, whilst the retention apparatus in turn provides an interface for the electrical connection to an electronic system of the electric bike. A charging function can then, for example, be integrated in the retention apparatus. A charging function which is integrated in this manner or a charging device which is integrated thereby in the retention apparatus may, for example, also be provided for coupling to another bicycle carrier which is fixed, for example, by means of a trailer coupling of the vehicle.

### BRIEF DESCRIPTION OF THE DRAWINGS

The appended Figures illustrate exemplary possible variants of the proposed solution.

FIG. 1 shows a sectioned plan view of an interior face of a vehicle interior of a variant of a proposed vehicle with a plurality of interior objects which can be freely displaced herein in the form of vehicle seats.

FIGS. 2A to 2C show a side view of the interior face of FIG. 1 with a vehicle seat in two different fixing positions and in different phases during a movement from a first fixing position to a second fixing position and a subsequent rotation of the vehicle seat.

FIG. 3 shows a perspective view of an embodiment of an omni wheel for use in the vehicle seat of FIGS. 2A to 2C.

FIG. 4 shows a plan view of another variant of an omni wheel for use in a vehicle seat of FIGS. 2A to 2C.

FIG. 5 shows a schematic plan view of the interior face of the vehicle of FIG. 1 illustrating an electronic detection device, which has at least one component on the interior object in the form of the vehicle seat.

FIGS. 6A to 6D show a cut-out, drawn to an enlarged scale, of a fixing apparatus having a displaceable carriage of a locking unit for locking a fixing element which is provided for the fixing in the form of a fixing pin.

FIG. 7A shows a perspective view of a development of the variant of FIGS. 6A to 6D with a locking unit which has the carriage and which is displaceably supported on guide rails of the fixing apparatus.

FIGS. 7B to 7F show different views of the fixing apparatus of FIG. 7A with the fixing pin in a position which is introduced into a fixing opening.

FIG. 8 shows the fixing apparatus of FIGS. 7A to 7F with a cut-out illustration of an object-side fixing pin prior to introduction into a fixing-face-side fixing opening which is further closed by means of a counter-element of the fixing apparatus.

FIGS. 9A to 9C show a cut-out view of various phases during introduction of the fixing pin into the fixing opening and the subsequent locking via the displaceable carriage of the fixing apparatus.

FIGS. 10A to 10D show sectioned views of one variant of a proposed fixing apparatus having a longitudinally displaceable locking unit which has a coupling region for an electrical connection to a pin-side coupling region.

FIGS. 11A and 11B show individual views of the fixing pin, which has a coupling region with two plug-in connectors, of the variant of FIGS. 10A to 10D.

FIG. 12 shows a cut-out sectioned view of the fixing apparatus with a fixing pin introduced into the fixing opening according to FIGS. 11A and 11B prior to plugging a counter-element of the displaceable locking unit to a fixing portion of the fixing pin.

FIG. 13 shows a cut-out of another variant of a fixing pin for one variant of a proposed fixing apparatus in which a fixing portion of the fixing pin can be electrically contacted in various adjustment positions of the fixing pin by a counter-element.

### DETAILED DESCRIPTION

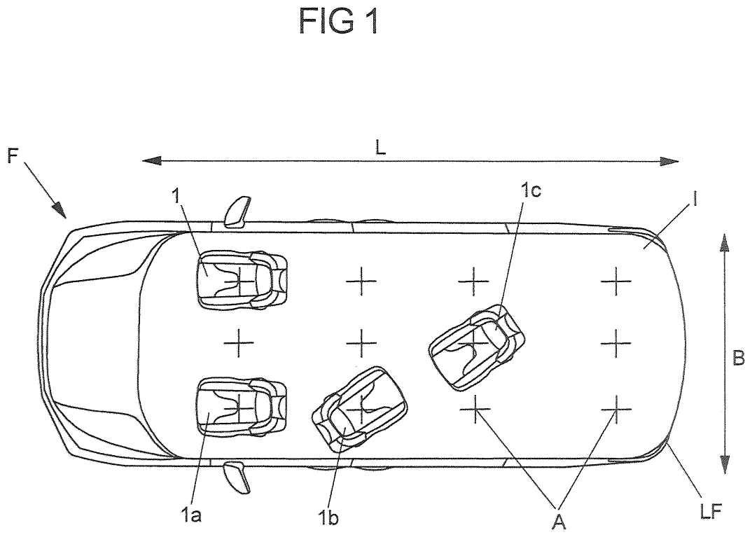

FIG. 1 shows by way of example a vehicle F which in the interior thereof defines a planar interior face I of a length L and a width B, which extends from an instrument panel of the vehicle F to a rear-side loading sill LF. The length L is, for example, in the range from 5 to 7.5 m and the width B is in the range from 1.5 to 2 m. On the interior face I there are provided a plurality of anchor locations A which act as fixing positions for fixing different interior objects. The anchor locations A are in this instance provided in a state distributed as corner locations of a virtual grid on the interior face I.

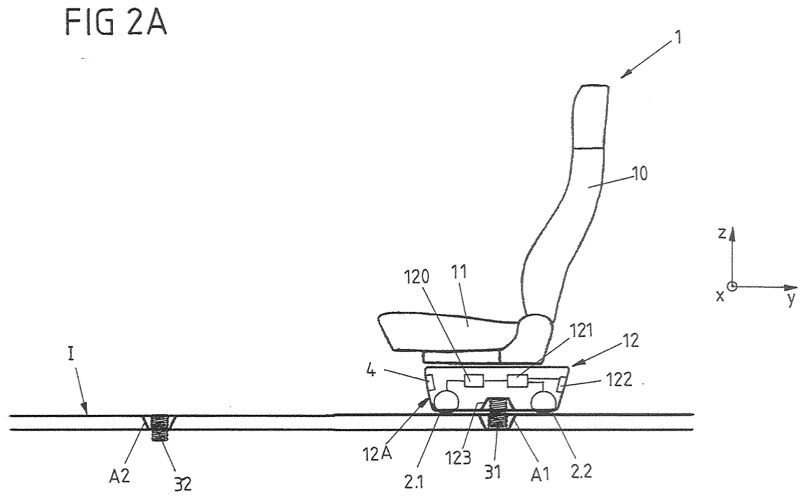

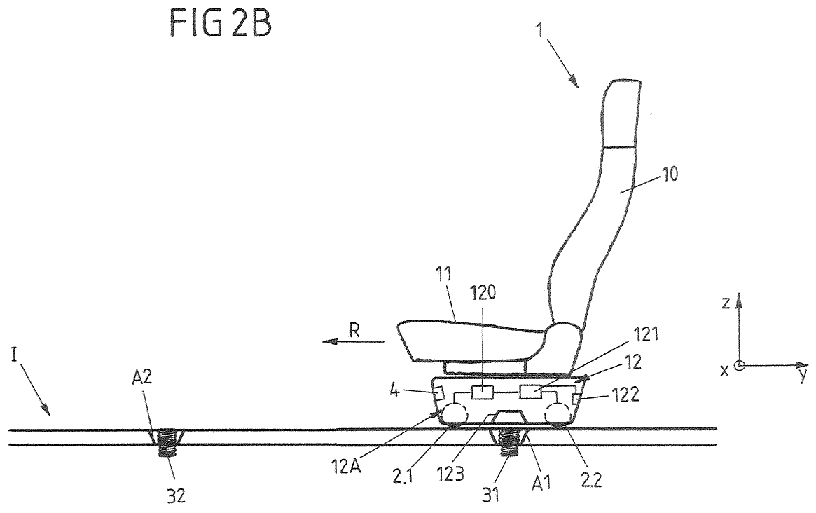

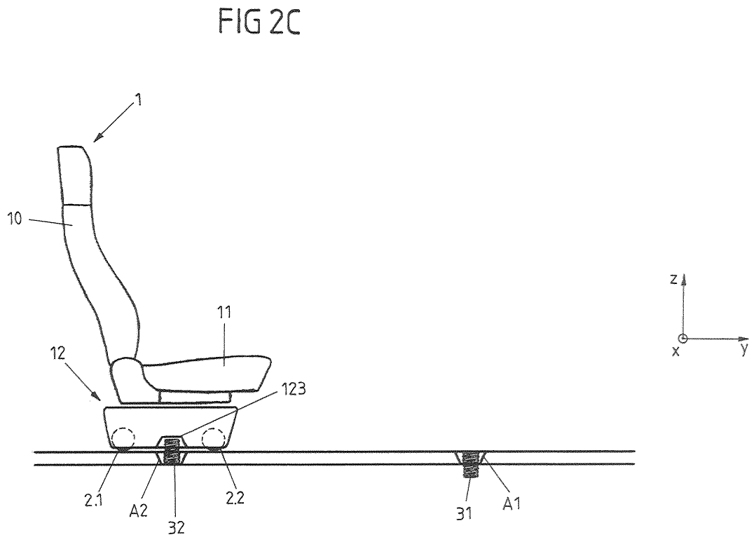

At the anchor locations A, in this instance, for example, different vehicle seats 1, 1a to 1c can be fixed as interior objects. In this case, the vehicle seats 1, 1a to 1c are in the form of freely adjustable units which can be moved in a non-mechanically guided manner, in particular a non-mechanically track-guided manner, on the interior face I. If a vehicle seat 1, 1a to 1c is correctly arranged at an anchor location A and arranged with a base 12 of the seat 1, 1a to 1c (cf. in particular FIGS. 2A to 2C), the respective vehicle seat 1, 1a to 1c can be fixed to the interior face 1 in a crash-secure manner. For example, a vehicle seat 1, 1a to 1c can be placed in such a manner over a rear loading sill LF (when the boot lid of the vehicle F is open) on the interior face I and then in a manner electronically controlled by a user, can move to a desired anchor location A on the interior face I and can be fixed at that location. The arrangement of different interior objects such as the vehicle seats 1, 1a to 1c is consequently extremely variable and can be virtually freely configured by a user.

In the side views of FIGS. 2A, 2B and 2C, a vehicle seat 1 is illustrated by way of example in greater detail. The vehicle seat 1 has a base 12 with a battery-operated motorized drive device 12A. The base 12 which can be moved via the motorized drive device 12A carries a seat portion 11 and a backrest 10 of the vehicle seat 1. The backrest 10 may in this instance be able to be adjusted in terms of its inclination with respect to the seat portion 11. Alternatively or additionally, the seat depth may be able to be adjusted by means of an adjustment of the seat portion 11 on the base 12.

The base 12 can be moved freely on the interior face I by means of an omni wheel or a plurality of omni wheels 2.1, 2.2. A torque for moving the vehicle seat is in this instance applied by means of a drive motor 120 which is accommodated within the base 12. This drive motor 120 is supplied with electrical power by means of a battery 121 which is accommodated inside the base 12 as an energy store. The battery 121 can in this instance be charged independently of the vehicle by means of a connection which is provided by a plug-in connector 122 on the base 12. The vehicle seat 1 can consequently be charged separately from the vehicle F at an electrical power supply. To this end, for example, a vehicle-independent charging station is provided.

If the vehicle seat 1 is positioned at one of the anchor locations A1, A2 illustrated in FIGS. 2A, 2B and 2C, the vehicle seat 1 can be fixed by means of a vehicle-side fixing element in the form of a fixing pin 31. To this end, the fixing pin 31, which is part of a fixing apparatus 3, is screwed at the anchor location A1 in an upward direction into a coupling portion 123 of the base 12, which defines a fixing opening for the fixing pin 31, 32. In addition to the fixing pin 31 which is illustrated by way of example, additional fixing elements and in particular fixing pins 31 may be provided in order to fix the base 12 and therefore the vehicle seat 1 to the anchor location A1 of the interior face I in a crash-secure manner.

Via the fixing pin 31 which engages in the base 12 and which is consequently present in a fixing position, in this instance a connection to a vehicle-side energy source, consequently a vehicle-side battery, may also be provided. Via the electrical connection, the battery 121 can then, for example, be charged (in particular when the vehicle is moving).

Alternatively or additionally, via the coupling to the electrical energy supply of the vehicle F at least one additional electromotive drive of the vehicle seat 1 may be able to be supplied with electrical power in order, for example, to adjust the backrest 10 or the seat portion 11 in an external-power-operated manner. The seat portion 11 may thus, for example, be able to be rotated on the base 12 about a vertical axis which extends parallel with a spatial direction z through more than 90°, in particular through up to 180° or even through 360° in an external-power-operated manner, at least when the base 12 is correctly fixed to an anchor location A1 (or A2; cf. FIG. 2C).

In response to a user operating request, the vehicle seat 1 can be moved from the anchor location A1 to another anchor location A2 on the interior face I. To this end, the fixing pin 31 is firstly retracted into a starting position on the interior face I and the base 12 is thereby released. The vehicle seat 1 can then be moved in a motorized manner using the omni wheels 2.1, 2.2 in a movement direction R from the anchor location A1 to the anchor location A2. This external-power-operated movement of the vehicle seat 1 is controlled via an electronic detection device D, which includes in this instance a detection element 4 which is provided on the base 12. This is, for example, in this instance a tag 4 which together with at least one vehicle-side sensor element of the detection device D enables an electronic detection of the position of the seat 1 on the interior face I.

In this manner, it is, for example, possible to electronically detect when the vehicle seat 1 has reached the (second) anchor location A2, in such a manner that a vehicle-side fixing pin 32 can engage on this (second) anchor location A2 in the coupling portion 123 of the base 12 in order to fix the vehicle seat 1 to the anchor location A2. Accordingly, the vehicle seat 1 may, for example, be rotated about the vertical axis through 180°.

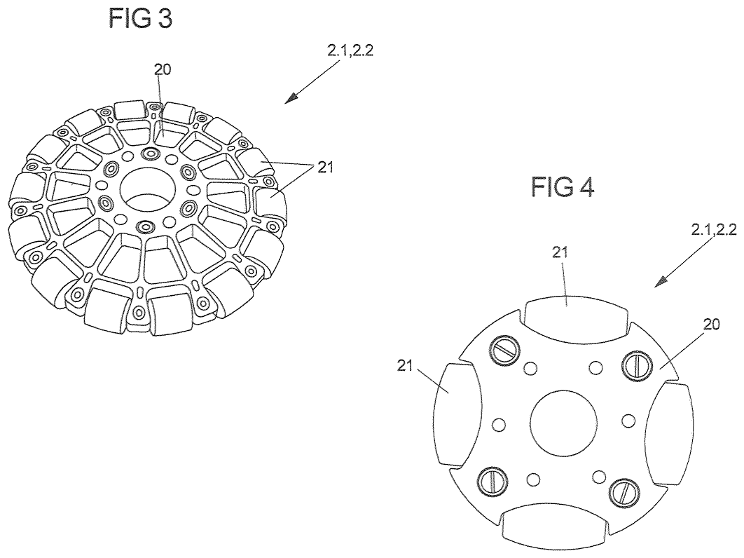

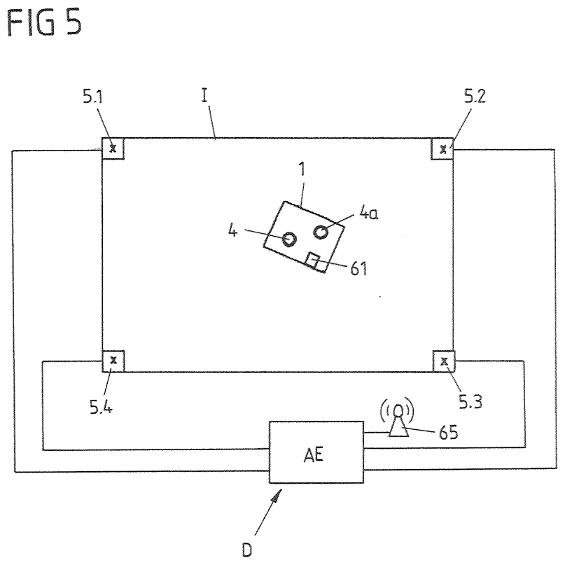

FIGS. 3 and 4 illustrate exemplary possible variants for an omni wheel 2.1, 2.2 on the base 12 of the vehicle seat 1. FIG. 3 shows in this instance, for example, in a perspective view, an omni wheel 2.1, 2.2 with a disk-like roller carrier 20 on which at the circumference a large number of rollers 21 are rotatably supported. In the variant of an omni wheel 2.1, 2.2 of FIG. 4, on a disk-like roller carrier 20 only four rollers 21 are rotatably arranged in a manner offset from each other through 90° in each case about a center of the roller carrier 20. Via each of the roller carriers of FIGS. 3 and 4, an adjustment in each spatial direction along a plane is possible.

FIG. 5 shows in a plan view by way of example a possible configuration of a detection device D, via which the position of a vehicle seat 1 can be detected during movement on the interior face I. In the variant illustrated, four sensor elements 5.1-5.4 are provided at defined positions of the vehicle interior and where applicable on the interior face I of the vehicle F (for example, at the corner locations thereof).

The vehicle seat 1 further has a tag 4 and where applicable an additional tag 4a. The tags 4, 4a can in this instance be detected by means of the sensor elements 5.1-5.4, for example, by the tags 4, 4a actively transmitting signals which can be received by the sensor elements 5.1-5.4 or by the sensor elements 5.1-5.4 being able to be read in the manner of an RFID label. In this manner, for example, using the detection device D, a position of the vehicle seat 1 inside a spatial detection field which is defined or monitored by the sensor elements 5.1-5.4 can be detected on the interior face I. Via an electronic evaluation system AE, which is coupled to the sensor elements 5.1-5.4, of the detection device D, a position of the vehicle seat 1 can then be determined from sensor signals produced on the interior face I, for example, by means of triangulation.

In order to improve the detection of a position of the vehicle seat 1 and to prevent occurrences of erroneous detection, different measurement principles are, for example, combined with each other so that the position of the vehicle seat 1 on the interior face I is monitored by means of sensor elements 5.1-5.4 using different measurement principles. For example, a Lidar system, a radio-based tracking based, for example, on electromagnetic waves, such as radar waves, UWB, Bluetooth, a search wire in the ground or on the ceiling, a detection based on infrared signals and/or ultrasound signals may thus be provided.

The detection device D further has in the variant of FIG. 5 in addition a transmitter unit 65 which, based on the position of the vehicle seat 1 on the interior face I as established by means of the electronic evaluation system AE, transmits control signals to the motorized drive device 12 of the vehicle seat 1. The vehicle seat 1 has in this instance, for example, also on the base 12, a receiver unit 61 which is configured to receive the control signals of the transmitter unit 65. The receiver unit 61 is coupled to the drive motor 120 of the base 12 in order to move the vehicle seat 1 in accordance with the control signals 65 and consequently in particular in accordance with the detected position of the vehicle seat 1 on the interior face I to a desired anchor location A, A1 or A2.

The movement of the vehicle seat 1 may in this instance be able to be controlled, for example, by a user using a control application, in particular a control application installed on a mobile telephone. Alternatively or additionally, a specific position of a vehicle seat 1 on the interior face I may be preconfigured, where applicable also in combination with predetermined positions for additional interior objects, such as, for example, a central arm console or a table. In this manner, a user may, for example, select a specific preconfiguration and via the detection device D have the vehicle seat 1—and where applicable additional interior objects—moved automatically into position. A corresponding control for the movement of a vehicle seat 1 (or other interior objects) on the interior face I can alternatively or additionally be integrated in the vehicle F. This includes in particular the adjustment and subsequent configuration of one or more preconfigurations in a vehicle-side operating unit for the arrangement of one or more interior objects.

In an exemplary method for moving a vehicle seat 1 using the detection device D, the device is for example, first switched on. Subsequently, the sensor elements 5.1-5.4 can synchronize and be tested for functionality. Then, using one of the sensor elements 5.1 one of the tags 4, 4a, for example, a first tag 4, is interrogated. This first tag 4 transmits a response signal which is received by all the sensor elements 5.1-5.4. There are then evaluated via the electronic evaluation system AE, the running time differences which are produced from the interrogation of the tag 4 and the (response) signal of the tag 4 received in response thereto on the individual sensor elements 5.1-5.4. From this, a position value which is then representative of the position of the tag 4 and consequently of the vehicle seat 1 can then be calculated.

Using a similar procedure for the additional tag 4a, another position value is produced for the vehicle seat 1. This additional position value can be used for (plausibility) testing of the position value established using the first tag 4 and/or in order to establish an orientation of the vehicle seat 1 with respect to the sensor elements 5.1-5.4 on the interior face 1. As a result of the position of two tags 4, 4a which are arranged in a specific fixed relative position with respect to each other on the vehicle seat 1, it is thus possible to establish not only the location of the vehicle seat 1, but also how the vehicle seat 1 or the base 12 thereof is orientated on the interior face I. Based on the established position(s) of the vehicle seat 1, the vehicle seat 1 then begins to move until it has reached a desired fixing position at which the vehicle seat 1 is fixed and can consequently be secured at an anchor location A, A1 or A2 in the reached fixing position.

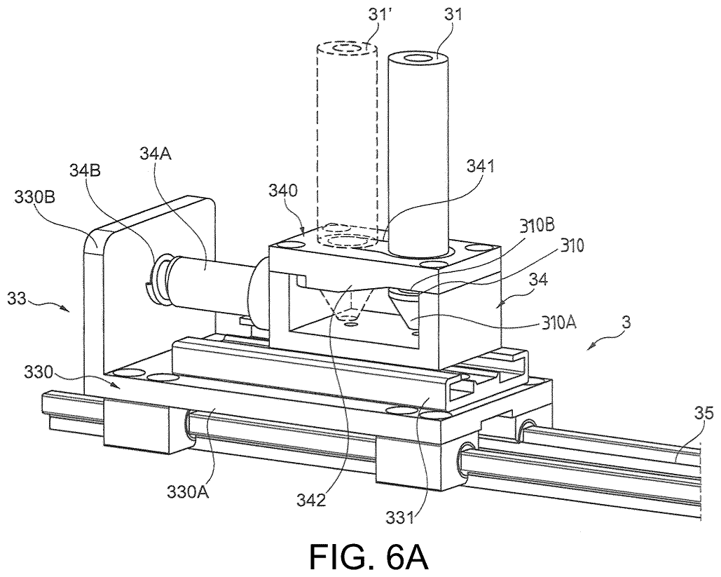

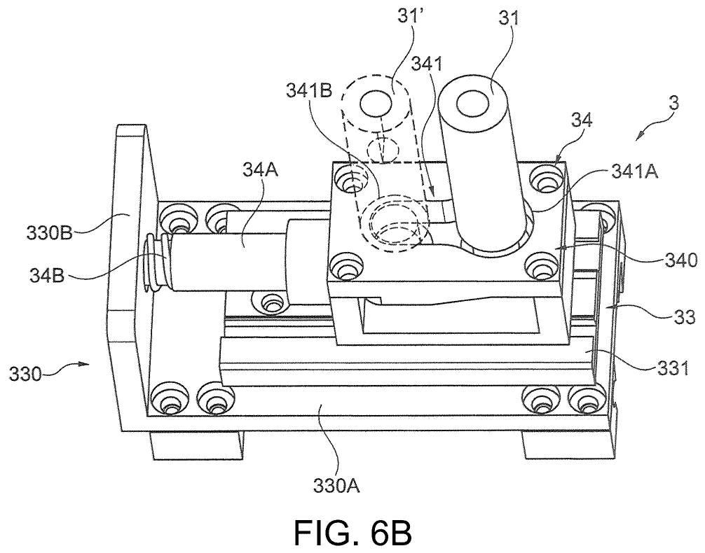

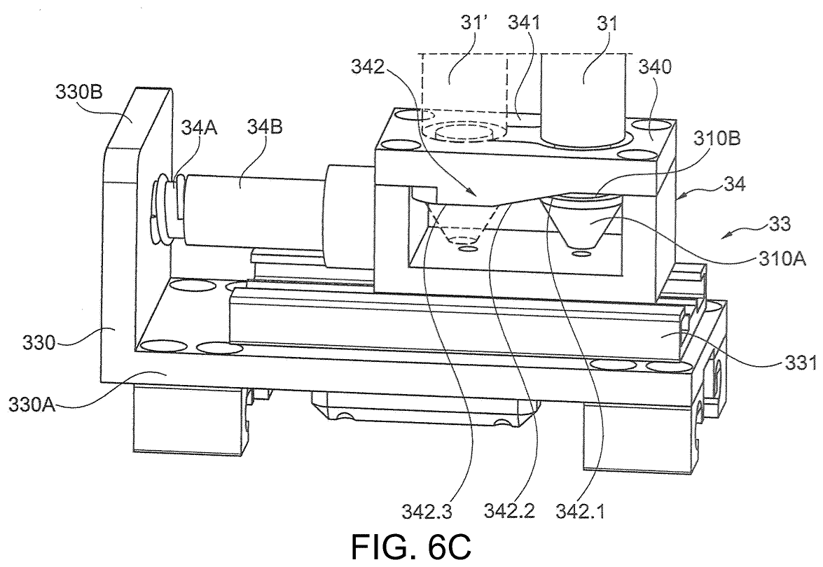

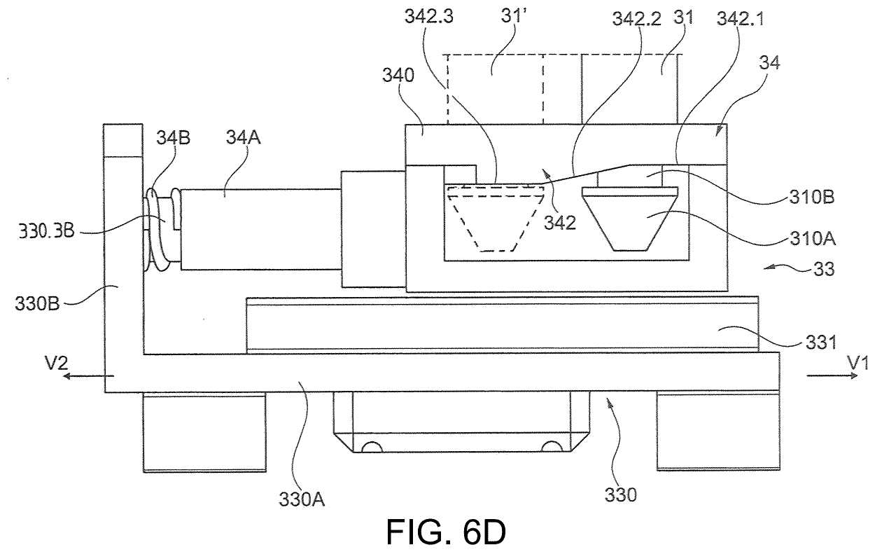

FIGS. 6A to 6D show cut-outs of other details of a fixing apparatus 3, as may be used in particular for a vehicle seat 1 of FIGS. 2A to 2C. In principle, however, one variant of a proposed fixing apparatus 3 may also be used with other objects, in particular with objects which are moved manually into a desired fixing position, for example, therefore deposited by a user at a fixing position.

FIGS. 6A to 6D show different views of an external-power-operated fixing using a displaceable locking unit 33 of the fixing apparatus 3.

In the variant illustrated in FIGS. 6A, 6B, 6C and 6D, a fixing pin 31 is constructed to protrude in each case rigidly at a lower side of the vehicle seat 1. In order to introduce the fixing pin 31 in a fixing opening on the interior face I, the vehicle seat 1 or at least a component, which carries the fixing pin 31, of the vehicle seat 1, such as, for example, the base 12, consequently has to be lowered to such an extent that a fixing portion 310 of the fixing pin 31 can be introduced into the fixing opening. This may, for example, be achieved by means of wheels of the vehicle seat 1 which can be lowered.

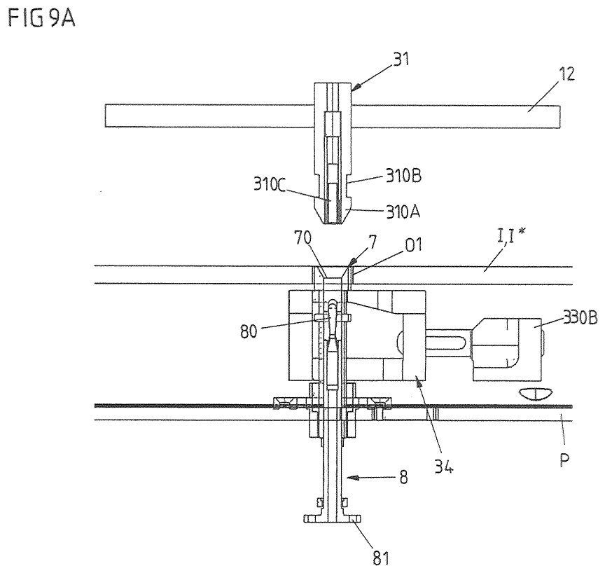

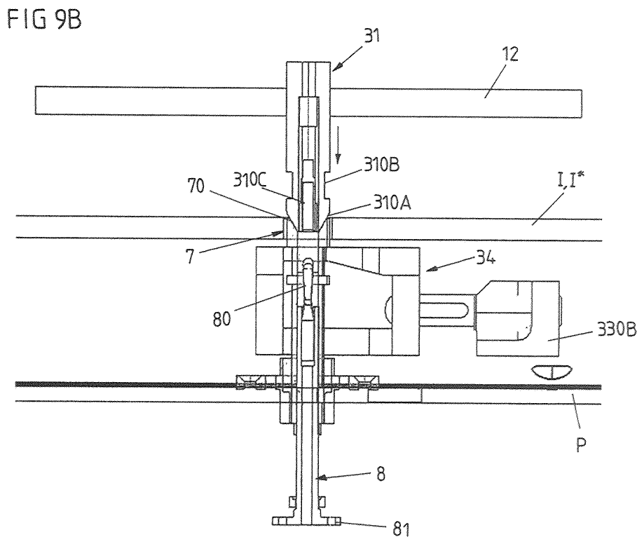

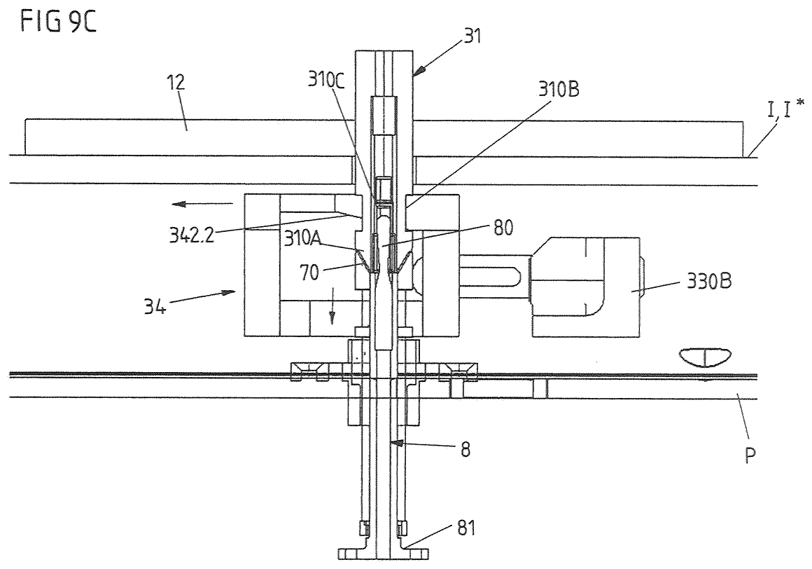

The fixing pin 31 protrudes in this instance with the fixing portion 310 from a through-opening on the vehicle seat 1, at the end of which, for easier introduction into a fixing opening O1 (cf. FIG. 9A) on the fixing face, in this instance the interior face I, an introduction cone 310A is formed.

For fixing the fixing pin 31 to the interior face I, a displaceable locking unit 33 is provided in this instance as part of the fixing apparatus 3. The locking unit 33 is displaceably supported below the interior face I by means of at least one guide rail 35 in mutually opposing adjustment directions V1 and V2. The adjustment directions V1 and V2 extend in this instance in each case transversely relative to an adjustment axis, along which the fixing pin 31 can be introduced into a respective fixing opening O1 on the interior face I.

The locking unit 33 is displaceably retained on the guide rail 35 by means of a base 330. On this base 330, a carriage 34 is in turn supported so as to be able to be longitudinally displaced. For the longitudinal displaceability of the carriage 34 on the base 330, a carriage guide 331 is provided on the base 330. This carriage guide 331 is carried by a guiding portion 330A of the base 330, via which the base 330 is displaceably retained on the guide rail 35. In a manner substantially perpendicular to this guiding portion 330A, the support member 330B protrudes on the base 330 which is consequently L-shaped in cross section.

The carriage 34 in in this instance resiliently pretensioned in the adjustment direction V1 against a base-side support member 330B by means of a resilient element in the form of a pressure spring 34B. To this end, the pressure spring 34B is supported, on the one hand, on the support member 330B and, on the other hand, on a carriage-side support sleeve 34A. In this manner, the carriage 34 can be displaced with the base 330 in the adjustment directions V1 and V2. At the same time, the carriage 34 can itself be additionally displaced on the base 330 and resiliently pretensioned in the adjustment direction V1. The pressure spring 34B is fitted onto the support member 330B on a bearing pin 330.3B which protrudes thereon.

In the adjustment direction V1, the locking unit 33 and consequently in particular the carriage 34 is displaced when the fixing pin 31 has been correctly introduced into a fixing opening O1 which is associated with the carriage 34 and accordingly the fixing pin 31 and consequently the respective object, in this instance, for example, the vehicle seat 1, is intended to be fixed on the interior face I. To this end, the carriage 34 has a locking plate 340 which faces the lower side of the interior face I and which has a locking opening 341. The locking opening 341 of the carriage-side locking plate 340 is arranged below the fixing opening O1 in the interior face, and initially in a release position, in which a first opening portion 341A of the locking opening 341 is brought into alignment with the fixing opening O1. At this first opening portion 341A, the locking opening 341 has sufficiently large dimensions so that the fixing pin 31 with the fixing portion 310 thereof which has the introduction cone 310A can engage through the fixing opening O1 into the locking opening 341 of the carriage 34. On the fixing portion of the fixing pin 31, an engagement region in the form of an annular groove 310B is formed, in this instance adjacent to the introduction cone 310A.

If the carriage 34 is in the release position thereof below the fixing opening O1, the fixing pin 31 can engage through the locking opening 341 on the first opening portion 341A in such a manner that the annular groove 310B protrudes below a release region 342.1 of a clamping portion 342 of the carriage 34, which is formed at two longitudinal sides of the locking plate 340. If following the introduction of the fixing pin 31 into the fixing opening O1, and consequently into the locking opening 341 of the carriage 34, the carriage 34 is displaced in the adjustment direction V1 transversely relative to the introduction direction of the fixing pin 31, a second opening portion 341B of the locking opening 341 comes into engagement with the fixing pin 31 on the annular groove 310B thereof. The second opening portion 341B has in this instance significantly smaller dimensions so that a shoulder, which adjoins in the direction of the introduction cone 310A, of the annular groove 310B prevents the fixing pin 31 from being pulled out of the locking opening 341. In this instance, the locking opening 341 has with the opening portions 341A, 341B thereof in plan view a keyhole-like contour. In the locking position, which is assumed as a result of the displacement in the adjustment direction V1, of the carriage 34, the carriage 34 is consequently locked as a locking element of the fixing apparatus 3 in a positive-locking manner to the fixing pin 31 on the fixing opening O1 and blocks it against being pulled out of the locking opening 341.

In order to further tension with the displacement of the carriage 34 into the locking position thereof the fixing pin 31 and consequently the object which carries the fixing pin 31 against the interior face I, the clamping portion 342 of the carriage 34 forms in the adjustment direction V2 adjacent to the release region 342.1 a ramp region 342.2. This ramp region 342.2 extends in an inclined manner with respect to the adjustment axis of the fixing pin 31 and consequently in an inclined manner relative to the original introduction direction of the fixing pin 31. When the carriage 34 is displaced in the adjustment direction V1, the carriage 34 slides with the locking plate 340 thereof over the ramp region 342.2 along the shoulder of the annular groove 310B and consequently presses—as a result of the inclination of the ramp region 342.2—the fixing pin 31 further in the original introduction direction (for example, downward in the illustration of FIG. 6D). If the carriage 34 is in the locking position thereof acted on with a pretensioning force by means of the pressure spring 34B, the fixing pin 31 was consequently displaced via the ramp region 342.2 of the clamping portion 342 into a clamping position and locked in such a clamping position in which a shoulder of the annular groove 310B engages behind the clamping portion 342 on a clamping region 342.3 which adjoins the ramp region 342.2 in the adjustment direction V2. The ramp region 342.2 of the clamping portion 342 on the carriage 34 consequently ensures a locking of the fixing pin 31 with tensioning on the carriage 34. As a result of the pressure spring 34B, which pretensions the carriage 34 in the adjustment direction V1, assuming the locking position is supported by the carriage 34.

In order to release the locking of the fixing pin 31 on the locking unit 33 and to release the fixing pin 31 again so that the vehicle seat 1 can be displaced on the interior face I again, the locking unit 33 and consequently the carriage 34 is adjusted back along the guide rail 35 in the adjustment direction V2. The fixing pin 31 is then no longer in the position 31′ which is illustrated with dashed lines in FIGS. 6A to 6D, but instead again in the region of the first (larger-sized) opening portion 341A of the locking opening 341. In this manner, the fixing pin 31 can again be pulled out of the locking unit 33 and consequently out of the fixing opening O1 at the interior face.

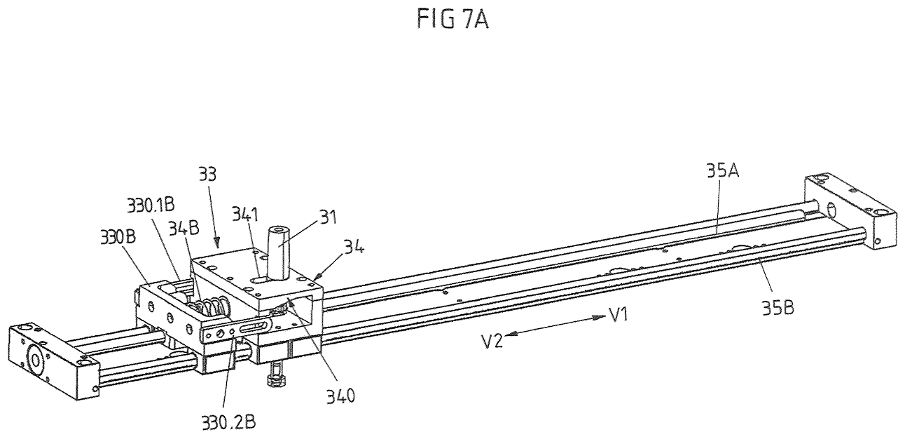

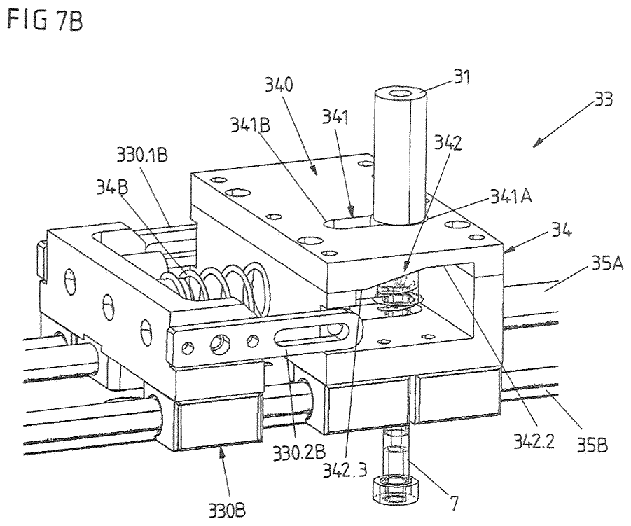

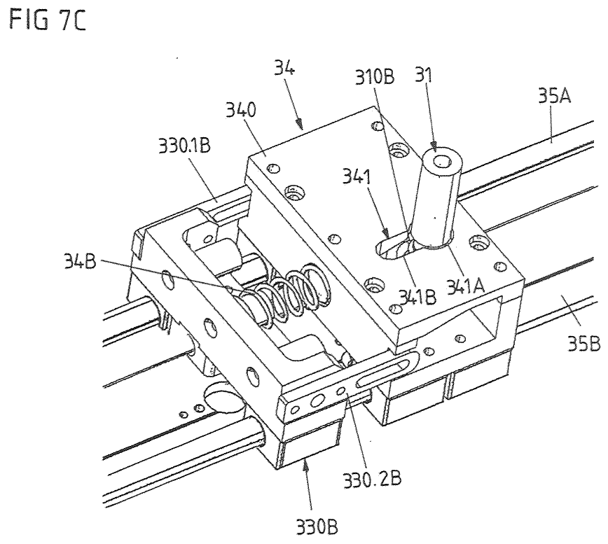

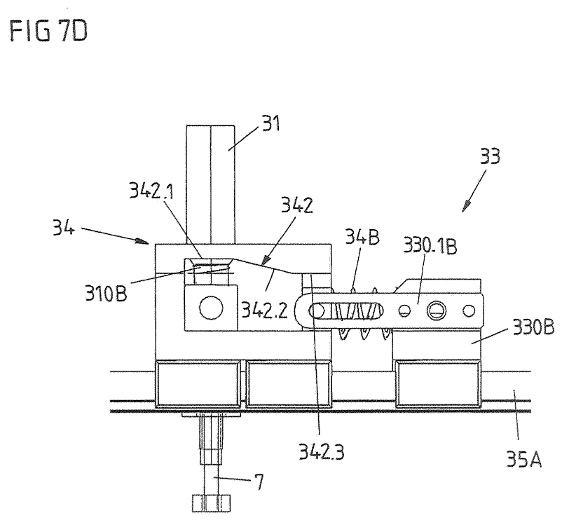

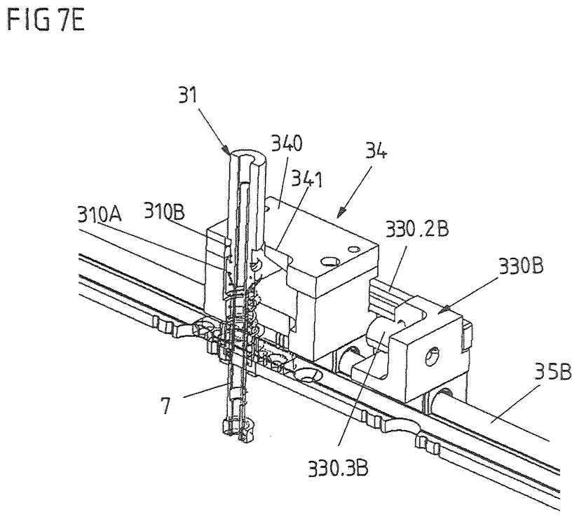

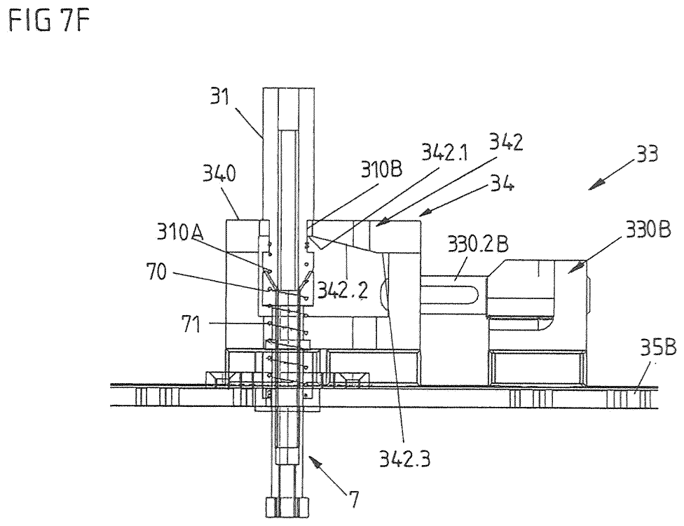

With the development of a fixing apparatus 3 as illustrated with FIGS. 7A to 7F, 8 and 9A to 9C, with a displaceably supported locking unit 33 elements which correspond to the variant of FIGS. 6A to 6D are given identical reference numerals.

As shown, for example, in the perspective view of FIG. 7A, in this instance the locking unit 33 of this development is displaceably supported on two mutually parallel guide rails 35A and 35B in the adjustment directions V1 and V2. In place of a base which carries the carriage 34 and the support member 330B together, in this instance the carriage 34 and the support member 330B are displaceably retained as separate components of the locking unit 33 directly on the guide rails 35A and 35B. In order to again act on the carriage 34 via the pressure spring 34B in an adjustment direction V1, the pressure spring 34B is supported, on the one hand, on the carriage 34 and, on the other hand, on the support member 330B. A drive force applied by a motor to displace the locking unit 33 is in this instance applied to the support member 330B relative to which the carriage 34 is supported in a longitudinally displaceable manner.

In order in this instance to limit the displaceability of the carriage 34 and the support member 330B relative to each other along the guide rails 35A, 35B, two mutually parallel connection arms 330.1B and 330.2B are provided. These connection arms 330.1B and 330.2B are fixed to the support member 330B and engage in each case via an elongate hole connection on the carriage 34. Via this elongate hole connection, a limited displaceability of the carriage 34 with respect to the support member 330B is provided and it is ensured that the carriage 34 is not only also displaced when the support member 330 is displaced but also additionally remains pretensioned via the pressure spring 34B when adjusted in the adjustment direction V1 with respect to the support member 330B.

As can be seen in particular with reference to the perspective illustrations of FIGS. 7B and 7C, the locking unit 33 of FIGS. 7A to 9C also has a locking plate 340 with a keyhole-like locking opening 341 and a clamping portion 342 with an obliquely extending ramp region 342.2 in order to ensure a locking of the fixing pin 31 on the locking unit 33 via a displacement of the carriage 34 in the adjustment direction V1.

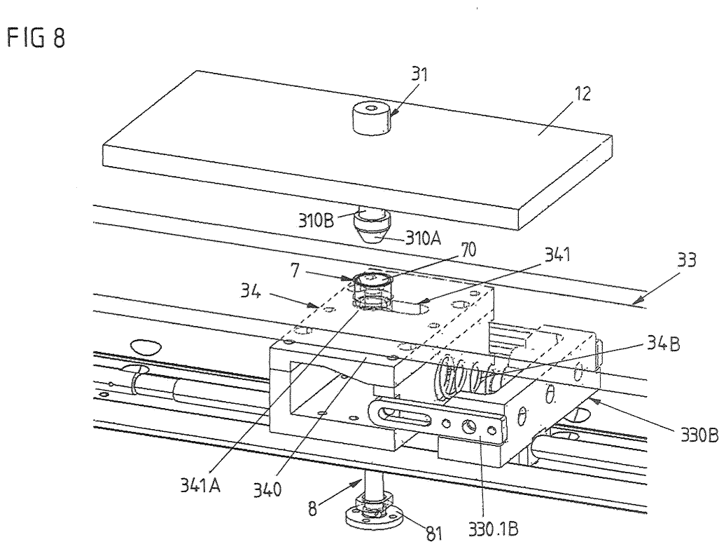

As can be seen from the sectioned and partially sectioned illustrations of FIGS. 7D, 7E and 7F, the fixing apparatus 3 further has in addition in this instance an adjustably supported counter-element 7. This counter-element 7 which is in this instance pin-like extends through the locking unit 33 and is pretensioned via a pressure spring 71 in the direction of the fixing opening O1. The counter-element 7 is displaced counter to the action of the pressure spring 71 when the fixing pin 31 is introduced. As shown in this instance by the perspective detailed illustration of FIG. 8 and the sectioned illustration of the FIGS. 9A, 9B and 9C, the counter-element 7 is in this instance pretensioned via the pressure spring 71 into a closure position in which the counter-element 7 terminates with a closure portion 70 the fixing opening O1 on the interior face I when no fixing pin 31 is inserted therein. If an object, such as, for example, the vehicle seat 1 is intended to be fixed to the fixing opening O1, the fixing pin 32 displaces the counter-element 7 counter to the action of the pressure spring 71 so that the fixing pin 31, as explained above, can engage through the fixing opening O1 and can engage in the locking opening 341 of the carriage 34. In order to facilitate the displacement of the counter-element 7, the closure portion 70 of the counter-element 7 has a conical receiving member as a counter-contour to the introduction cone 310A of the fixing pin 31 into which the introduction cone 310A can be inserted.

As shown in particular in FIGS. 8 and 9A to 9C, in the illustrated variant the counter-element 7 is supported on a retention member in the form of an insertion pin 8 so as to be longitudinally displaceable (along the adjustment axis of the fixing pin 31). This insertion pin 8 which is fixed in a non-movable manner is fixed by means of a locking base 81, for example, at the body side, so that the carriage 34 can be adjusted relative thereto. The insertion pin 8 extends in this instance through a base plate P which is provided between the guide rails 35A and 35B. In this instance, for example, the counter-element 7 which encloses the insertion pin 8 in the manner of a sleeve may also be able to be at least partially displaced through a through-opening in this base plate P in order to change between the closed position thereof and an adjustment position which is displaced by means of the fixing pin 31.

The insertion pin 8 further carries a contact element in the form of a contact head 80 relative to which the counter-element 7 can be displaced. To this end, the contact head 80 is received centrally in a sleeve-like portion of the counter-element 7.

The contact head 80 is accessible within the carriage 34 by displacing the counter-element 7 when the fixing pin has been introduced to a sufficient extent (with the counter-element 7 being displaced) into the fixing opening O1. If the fixing pin 31 after longitudinal displacement of the carriage 34 in the adjustment direction V1 is located in the clamping position thereof (and consequently the carriage 34 is in the locking position thereof), the contact head 80 protrudes from the closure portion 70 of the counter-element 7 and protrudes through an opening which is formed on the introduction cone 310A into the fixing pin 31. Inside the fixing pin 31, a contact/plug-in sleeve 310C, by means of which the inserted contact head 80 produces an electrical connection when the fixing pin 31 has been correctly locked on the carriage 31 according to FIG. 9C, is provided. In this manner, with the locking of the fixing pin 31 on the locking unit 33, an electrical connection can also be provided between the object to be fixed and a vehicle-side power source and/or superordinate electronic control system, particularly via the fixing element which is also used for fixing, in this instance in the form of the fixing pin 31.

Via the illustrated fixing apparatus 3, the fixing of another object—for example, in the form of a battery carrier—on a fixing face I* can also be carried out. For example, a fixing of the battery carrier on a lower side of a vehicle base as a fixing face is possible. A plurality of battery cells for an electric vehicle, such as, for example, an electric car, can thus be arranged on the battery carrier. Via a fixing apparatus 3 having a locking unit 33 and at least one fixing element 31 (configured accordingly in a stable manner) or a plurality of fixing elements, such a battery carrier which carries a plurality of battery cells can consequently be electronically controlled in a simple manner and fixed in an external-power-operated manner to a vehicle base.

In principle, a plurality of locking units 33 may also be provided with a plurality of fixing elements for fixing a single object at a fixing position at the object side or vehicle side.

Furthermore, alternatively or additionally in place of the contacting which is illustrated with FIGS. 9A to 9C between the fixing pin 31 and the vehicle-side counter-element 7 for the production of an electrical connection, the locking carriage 34 (alone) can be used. The locking carriage 34 can thus, for example, have an electrically conductive coupling region which when the locking carriage 34 is adjusted into its locking position is brought into contact with a corresponding coupling region on the fixing portion 310 of the fixing pin 31. Accordingly in this instance, an electrical connection is then produced not via the (in this instance vertical) adjustment movement of the fixing pin 31, but instead via a/an (typically horizontal) adjustment movement of the locking element 34 which extends in this instance perpendicularly relative thereto.

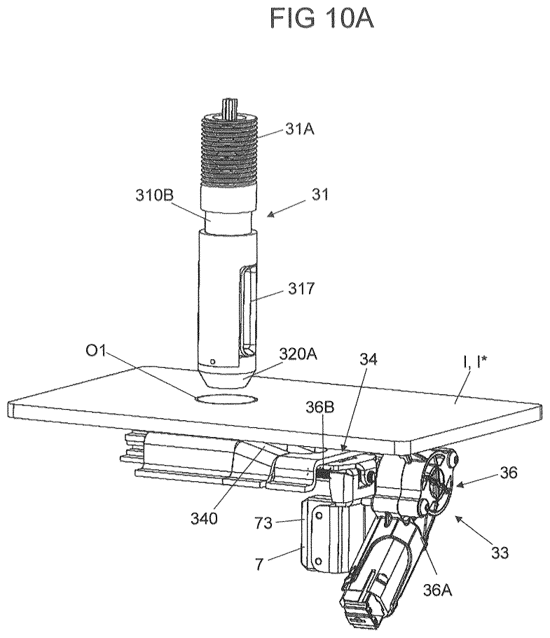

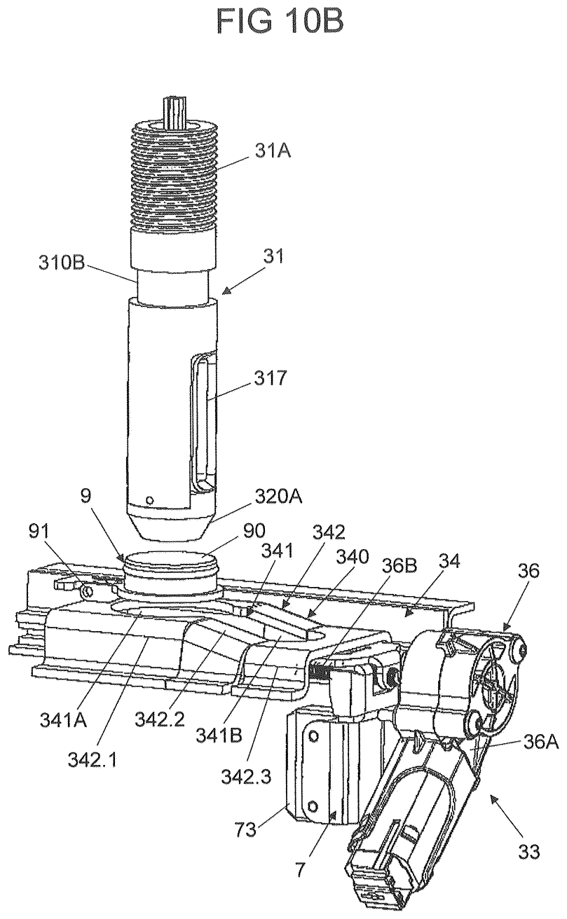

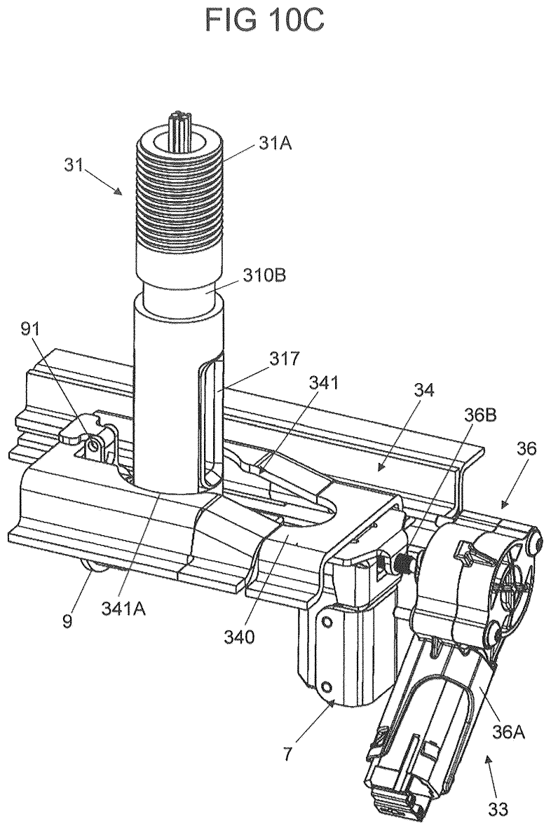

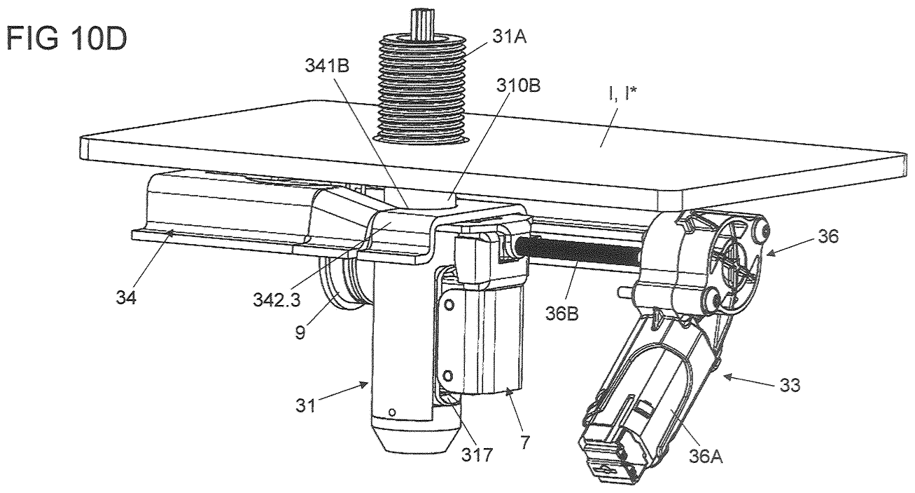

FIGS. 10A to 12B and 13 show variants of a developed fixing apparatus according to the proposed solution, in which an electrical connection between a coupling region 317 of a fixing pin 31 and a carriage-side coupling region 73 is produced by means of an adjustment movement of the locking carriage 34 which extends perpendicularly to an adjustment movement of the fixing pin 31.

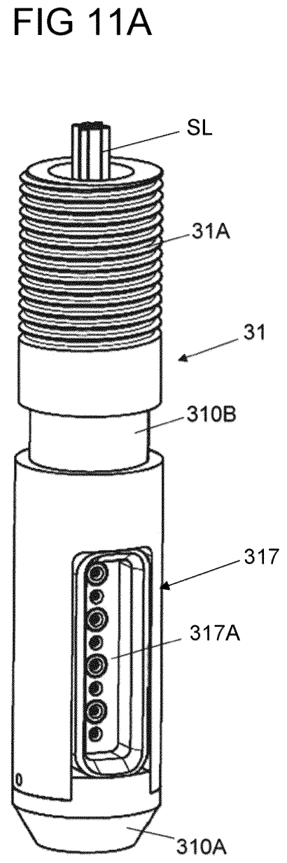

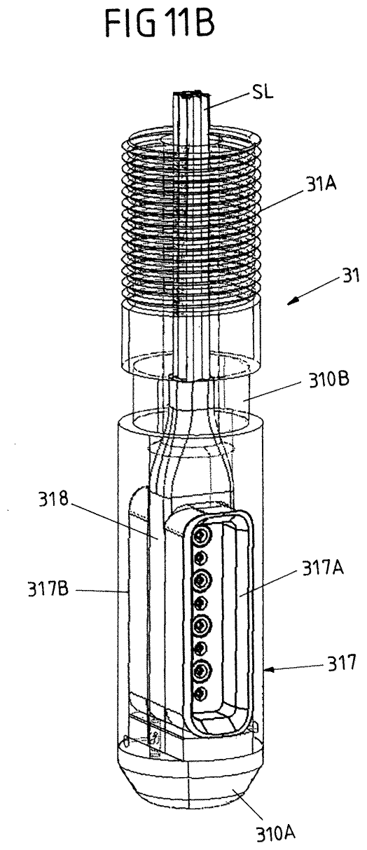

On the locking carriage 34 which carries the locking plate 340 with the locking opening 341, a counter-element 7 which has the coupling region 73 is fixed for this purpose. This coupling region 73 is, for example, in the form of a plug-in connector. If the fixing pin 31 of the variant of FIGS. 10A to 10D which is illustrated in FIGS. 11A and 11B in single views is introduced to such an extent into the through-opening O1 that the locking carriage 34 can engage via the locking opening 341 in a clamping manner into the annular groove 310B of the fixing pin 31, the bolt-side coupling region 317 is located below the locking plate 340 and opposite the carriage-side coupling region 73. As a result of translational adjustment of the locking carriage 34, the carriage-side coupling region 73 can then be fitted on the pin-side coupling regions 371 when the locking of the fixing pin 31 is carried out on the locking carriage 34.

For the translational adjustment of the locking carriage 34, the locking unit 33 of the variant of FIGS. 10A to 10D has an electromotive drive 36. The drive 36 comprises in this instance an electric motor unit 36A via which a (drive) spindle 36B can be driven. A spindle nut of the locking carriage 34 meshes with the spindle 36B so that, as a result of the electromotively driven rotation of the spindle 36B, the locking carriage 34 can be adjusted in translation along the spindle axis. As a result of this adjustment, the locking plate 340 can lock or release the fixing pin 31.

In the variant illustrated in FIGS. 10A to 10D and 11A and 11B, the fixing pin 31 has above the annular groove 310B (and consequently at the end opposite the introduction cone 310A) a drive portion 31A. At this drive portion 31A, a drive movement is introduced into the fixing pin 31 in order to introduce it into the through-opening O1 or to pull it out of the through-opening O1. For example, the drive portion 31A has an outer thread for this purpose.

In the variant of FIGS. 10A to 10D and 11A to 11B there is further provision for the through-opening O1 to be closed at the fixing face 1, 1*—when the fixing pin 31 is not introduced—by a separate closure element 9. This closure element 9 is pivotably supported between a closure position and an open position about a pivot axis 91, in this instance on the locking carriage, for example, alternatively at a lower side of the fixing face I, I*. In the closure position, the closure element 9 protrudes with a closure portion 90 into the through-opening O1 and closes it completely. When the fixing pin 31 is introduced into the through-opening O1, the closure portion 90 which is resiliently pretensioned into the closure position, for example, by means of a resilient element, is displaced in the direction of the open position.

In the variant of FIGS. 10A to 10D and 11A to 11B, the closure portion 90 can be pivoted, for example, through more than 70° in particular through 90° from the closure position into the open position about the pivot axis 91. In this instance, the closure portion 90 is retained in the open position by means of the correctly introduced fixing pin 31 so that the closure portion 90 is displaced back into the closure position and closes the through-opening O1 again only when the fixing pin 31 is pulled out of the through-opening O1. The closure element 9 is in this instance fixed to the locking carriage 34 and is consequently secured to the carriage. In this instance, the guiding element 9 is provided at the edge in the region of the opening portion 341A of the locking opening 341, for example, secured to the locking plate 340. Furthermore, the closure portion 90 of the closure element 9 is sized in such a manner that the closure portion 90, in the event of a pivot movement from the closure position thereof into the open position, can be displaced through the locking opening 341 in the locking plate 340.

In order to be able to electrically couple the counter-element 7 to the fixing pin 31 in the variant of FIGS. 10A to 12 in different displacement positions of the fixing pin 31 and resultant different orientations of a vehicle seat 1, 1a-1d (or another object on which the fixing pin 31 is provided), the coupling region 317 is formed on the fixing portion of the fixing pin 31 with two plug-in connectors 317A and 317B. The two plug-in connectors 317A, 317B are accessible in two mutually perpendicular spatial directions on an outer covering face of the fixing pin 31. In this manner, a counter-element 7 can either be attached to one plug-in connector 317A of the pin-side coupling region 317 or to the other plug-in connector 317B of the pin-side coupling region 317, depending on whether the fixing pin 31 and consequently the object which carries it is introduced into the fixing opening O1 in one displacement position or in a displacement position which is rotated through 180° about the adjustment axis. The fixing pin 31 can consequently also be used in the event of a rotation through 180° in order to attach the counter-element 7 to the coupling region 317. A counter-element can thus be inserted from both sides on the fixing portion of the fixing pin 31.

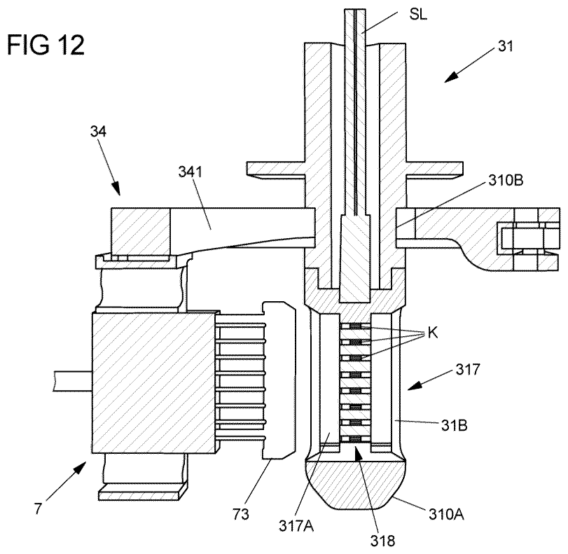

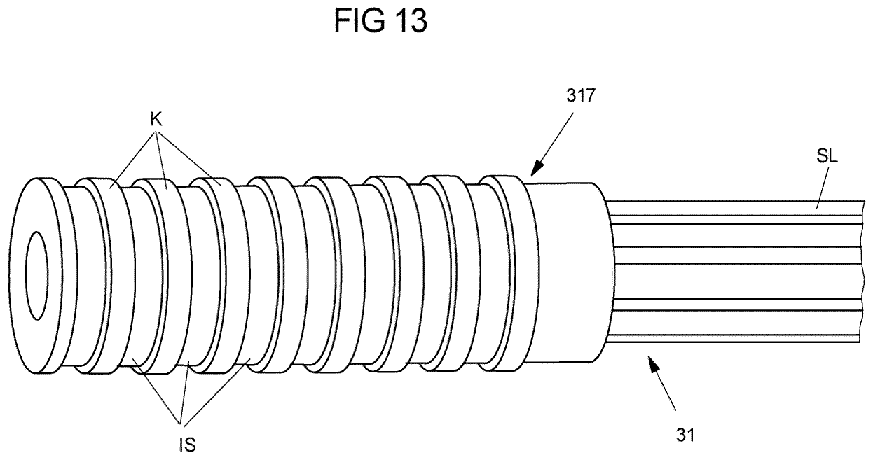

As can be seen in particular with reference to the sectioned illustrations of FIGS. 11B and 12, the fixing pin 31 has in the interior thereof a central portion 318 which connects the two plug-in connectors 317A and 317B. A signal line SL which is connected to contacts K of the plug-in connectors 317A, 317B is also fixed to this central portion 318. The contacts K are in the variant of FIGS. 10A to 12 in the form of socket contacts and arranged in the central portion 318 so that the ends of the socket contacts K are accessible via each of the plug-in connectors 317A, 317B. A corresponding (counter) plug-in connector of the counter-element 7 can thus be fitted onto the socket contacts K from two mutually opposing sides.

In the variant illustrated, the socket contacts K of the fixing pin 31 are further arranged along the adjustment axis and consequently in a parallel extent direction of the fixing pin 31 in a linear manner one behind the other. In principle, however, another arrangement of the contacts K is of course also possible on the coupling region 317.

In an alternative variant according to FIG. 13, the fixing pin 31 has on the fixing portion thereof which is intended to be introduced into the fixing opening O1 and which is intended, for example, to be locked with a locking carriage 34, a coupling region 317 for coaxial contacting of a counter-element, for example, in a similar manner to the variant of FIGS. 7A to 8. The coupling region 317 of FIG. 13 is to this end formed with round contacts K which extend in an annular manner around the fixing portion. The individual round contacts K are in this instance in each case separated from each other in pairs by means of an insulating portion IS. In this manner, in an extent direction of the fixing pin 31, a plurality of round contacts K with in each case annularly extending contact faces are arranged in a state separated from each other by means of insulating portions IS one behind the other on the fixing portion.

The provision of the round contacts K on an outer covering face of the fixing portion also enables contacting with a counter-element in a plurality of (at least two) different adjustment positions of the fixing pin 31 with respect to the fixing opening O1. In this instance, an electrical connection after locking via the fixing pin 31 is ultimately possible in any adjustment position, which can be assumed by means of rotation about the adjustment axis, of the fixing pin 31. Whilst with the variant FIGS. 10A to 12 a correct electrical connection to a counter-element 7 is therefore possible by means of a plug-in connector in each case in two adjustment positions which are rotated through 180° about the adjustment axis, a corresponding coupling in the variant of FIG. 13 is possible regardless of the angle. In both cases, however, in particular a fixing of an interior object, such as, for example, a vehicle seat 1, 1a to 1c in different orientations, in particular in 0° and 180° with respect to the travel direction is possible, which leads to an increased variability in the configuration of the vehicle interior and the components which are intended to be arranged there.

### LIST OF REFERENCE NUMERALS

1, 1a, 1b, 1c Vehicle seat (interior object)
10 Backrest (adjustment portion)
11 Seat portion (adjustment portion))
12 Base
120 Drive motor
121 Battery
122 Plug-in connector
123 Coupling portion
12A Drive device
2.1, 2.2 Omni wheel
20 Roller carrier
21 Roller
3 Fixing apparatus
31, 31′ Fixing pin (fixing element)
310A Introduction cone
310B Annular groove (engagement region)
310C Contact (plug-in sleeve)
317 Coupling region
317A, 317B Plug-in connector
318 Central portion
31A Drive portion
32 Fixing pin (fixing element)
33 Locking unit
330 Base
330.1B, 330.2B Connection arm
330.3B Bearing pin
330A Guiding portion
330B Support member
331 Carriage guide
34 Locking carriage (locking element)
340 Locking plate
341 Locking opening
341A, 341B Opening portion
342 Clamping portion
342.1 Release region
342.2 Ramp region
342.3 Clamping region
34A Support sleeve
34B Pressure spring (resilient element)
35A, 35B Guide rail
36 Drive
36A Electric motor unit
36B Spindle
4, 4a Tag (detection element)
5.4 Sensor element
61 Receiver unit
65 Transmitter unit
7 Counter-element
70 Closure portion
71 Pressure spring
73 Coupling region
8 Plug-in pin (retention member)
80 Contact head (contact element)
81 Locking base
9 Closure element
90 Closure portion
91 Pivot axis
A, A1, A2 Anchor location (fixing position)
AE Electronic evaluation system
B Width
D Detection device
F Vehicle
I, I* Interior face (fixing face)
IS Insulating portion
K (Socket/round) contact
L Length
LF Loading edge
O1 Fixing opening
P Base plate
R Movement direction
SL Signal line
V1, V2 Adjustment direction

1. A fixing apparatus for fixing an object to a fixing face in a vehicle, having at least one fixing element, which is constructed for fixing the object having a fixing portion which for engagement in a fixing opening can be introduced along an adjustment axis into the fixing opening,
wherein the fixing element has on an outer covering face of the fixing portion a coupling region which in at least two different adjustment positions of the fixing element, in which the fixing portion can be introduced in each case into the fixing opening, permits an electrical contacting by a counter-element.

2. The fixing apparatus as claimed in claim 1, wherein the coupling region permits an electrical contacting with the counter-element when the fixing portion engages in the fixing opening both in a first adjustment position of the fixing element and in at least a second adjustment position of the fixing element, wherein the second adjustment position can be assumed starting from the first adjustment position by rotating the fixing element about the adjustment axis.

3. The fixing apparatus as claimed in claim 2, wherein the coupling region permits an electrical contacting with the counter-element when the fixing portion engages in the fixing opening in two different adjustment positions in which the fixing element is rotated through more than 90° about the adjustment axis.

4. The fixing apparatus as claimed in claim 1, wherein the coupling region has contacts which are connected to at least one signal line and which can be coupled to the counter-element in at least two different spatial directions which are in each case perpendicular to the adjustment axis.

5. The fixing apparatus as claimed in claim 1, wherein the coupling region, for a plug-in connection to the counter-element in the at least two different adjustment positions, has at least two plug-in connectors on the outer covering face of the fixing portion.

6. The fixing apparatus as claimed in claim 5, wherein the two plug-in connectors are connected to each other by means of a central portion of the fixing portion.

7. (canceled)

8. The fixing apparatus as claimed in claim 4, wherein the contacts are in the form of socket contacts.

9. The fixing apparatus as claimed in claim 8, wherein a plurality of socket contacts are arranged one behind the other in an extent direction, which is parallel with the adjustment axis, of the fixing portion.

10. The fixing apparatus as claimed in claim 4, wherein on the coupling region the contacts are in the form of round contacts in which a contact face which is intended in each case to be electrically contacted by the counter-element extends on the outer covering face of the fixing portion in a circumferential direction about the adjustment axis.

11. (canceled)

12. (canceled)

13. The fixing apparatus as claimed in claim 1, wherein there is provided at least one adjustable locking element which is separate from the fixing element and which in interaction with the fixing portion which engages in the fixing opening locks the fixing element in the fixing opening and blocks the fixing portion against removal from the fixing opening.

14. The fixing apparatus as claimed in claim 13, wherein the at least one locking element in order to lock the fixing element can be adjusted into a locking position in which the at least one locking element is connected to the fixing portion in a positive-locking manner.

15. The fixing apparatus as claimed in claim 13, wherein the at least one locking element is displaceably supported in an adjustment direction which extends transversely relative to the adjustment axis of the fixing portion.

16. The fixing apparatus as claimed in claim 15, wherein the locking element comprises a displaceably supported carriage.

17. The fixing apparatus as claimed in claim 16, wherein there is provided on the carriage a locking opening in which the fixing portion, which has been introduced into the fixing opening, of the fixing element engages.

18. A vehicle having
an object which is intended to be fixed,
a fixing face which is secured to the body, and
at least one fixing apparatus as claimed in claim 1 for fixing the object to the fixing face.

19. The vehicle as claimed in claim 18, wherein the fixing apparatus is provided on the fixing face or on the object.

20. The vehicle as claimed in claim 18, wherein the fixing face is provided in a vehicle interior of the vehicle and there is provided an electronic detection device which is configured to detect a position of the object on the interior face.

21. The vehicle as claimed in claim 18, wherein the object comprises at least one of a vehicle seat, and/or a console and a battery carrier.

22. A vehicle seat having a fixing apparatus as claimed in claim 1 for fixing the vehicle seat to an interior face of the vehicle.

23. A battery carrier having at least one battery cell for a drive of a vehicle and a fixing apparatus as claimed in claim 1 for fixing the battery carrier in the vehicle.
